(19) United States
(12) Patent Application Publication
(10) Pub. No.: US 2008/0010094 A1
(43) Pub. Date: Jan. 10, 2008

(54) DISTRIBUTION OF HEALTH INFORMATION FOR PROVIDING HEALTH RELATED SERVICES

(76) Inventors: Mark Carlson, Half Moon Bay, CA (US); Edward Katzin, San Francisco, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/765,550

(22) Filed: Jun. 20, 2007

Related U.S. Application Data
(60) Provisional application No. 60/815,618, filed on Jun. 21, 2006.

(51) Int. Cl. G06Q 50/00; G06F 17/30; G06F 17/40

(52) U.S. Cl. 705/3

(57) ABSTRACT

A method for storage and access to patient information over a payment processing network is disclosed. One embodiment of the invention includes collecting medical information from various medical institutions via a payment processing network, storing the collected medical information at a central location, and providing, upon request, specific medical information to a requester from the stored collected medical information.

### CROSS-REFERENCES TO RELATED APPLICATIONS

This patent application is a non-provisional of and claims priority to U.S. provisional patent application No. 60/815,618, filed on Jun. 21, 2006, which is herein incorporated by reference in its entirety for all purposes.

### BACKGROUND

Mistakes caused by incomplete or inaccurate patient information such as drug allergies or blood type cost tens of thousands of lives a year. Accurate and timely access to healthcare records could help healthcare providers avoid making mistakes when treating patients. Medical institutions and related organizations recognize that having patient information available electronically will result in safer treatment, significant cost savings, and more efficient access to patent information. Thus, many organizations have converted paper files to digital files and implemented computer systems for their particular organization.

This may work well for accessing patient information if the patient stays within that organization, but a patient may change organizations because he or she moves or changes healthcare insurance. Also, a patient may use several organizations for his or her healthcare needs. For example, a patient may go to her primary doctor with back pain. The primary doctor may prescribe medication for the back pain and refer her to a specialist who is in a different organization. The patient will fill the prescription at a pharmacy which is typically a separate organization. The doctor may also request blood tests or other lab work which may be done by yet another organization. Once the patient visits the specialist, she may have to remember to list her drug allergies on new forms, bring her lab results and remember past diagnoses from her primary doctor. Or her appointment may be delayed while the specialist requests the various paper or electronic documents from the primary doctor.

If this were an emergency situation this would be an even more serious problem. If a patient has been in a serious accident and is rushed to a hospital emergency room, there is often no time to determine blood type and drug allergies or request this information from the patient's primary doctor.

Thus, there is a recognized need for healthcare providers to have access to different patient health services systems to reduce medical errors, improve healthcare quality, lower cost, and enhance the privacy and security of patient information and general medical information from various healthcare institutions and related organizations. Embodiments of the invention address these and other problems individually and collectively.

### BRIEF SUMMARY

Embodiments of the invention are directed to methods, systems, and computer readable media for allowing access to patient records from various medical institutions to be conducted in a secure and efficient manner.

One embodiment of the invention is directed to a method comprising collecting medical information from various medical institutions via a payment processing network, storing the collected medical information at a central location, and providing, upon request, specific medical information to a requester from the stored collected medical information.

Another embodiment of the invention is directed to a method comprising requesting medical information using a provider access device wherein the requested medical information is collected from various medical institutions via a payment processing network and stored at a central location, and receiving the medical information wherein the requested medical information is provided from the stored medical information.

Another embodiment of the invention is directed to a method comprising receiving a request for medical information from a request broker via a payment processing network, and providing the medical information to the request broker via a payment processing network wherein the medical information is stored at a central location.

Another embodiment of the invention is directed to a method comprising requesting medical information using a portable consumer device wherein the requested medical information is collected from various medical institutions via a payment processing network and stored at a central location, and receiving the medical information wherein the requested medical information is provided from the stored medical information.

Another embodiment of the invention is directed to a method comprising requesting medical information using a portable consumer device wherein the requested medical information is collected from various medical institutions via a payment processing network and stored at a central location, receiving the medical information wherein the requested medical information is provided from the stored medical information, sending a payment request using the portable consumer device and receiving an authorization response message indicating that payment is authorized.

These and other embodiments of the invention are described in further detail below.

### BRIEF DESCRIPTION OF THE DRAWINGS

FIG. 1 shows a block diagram of a system according to an embodiment of the invention.

FIG. 2 shows a flowchart illustrating steps in a method according to an embodiment of the invention.

### DETAILED DESCRIPTION

Embodiments of this invention allow providers of healthcare, such as doctors or nurses, to use a provider access device to securely and efficiently access a variety of health records at various medical institutions such as hospitals, laboratories, pharmacies, etc., over a payment processing network.

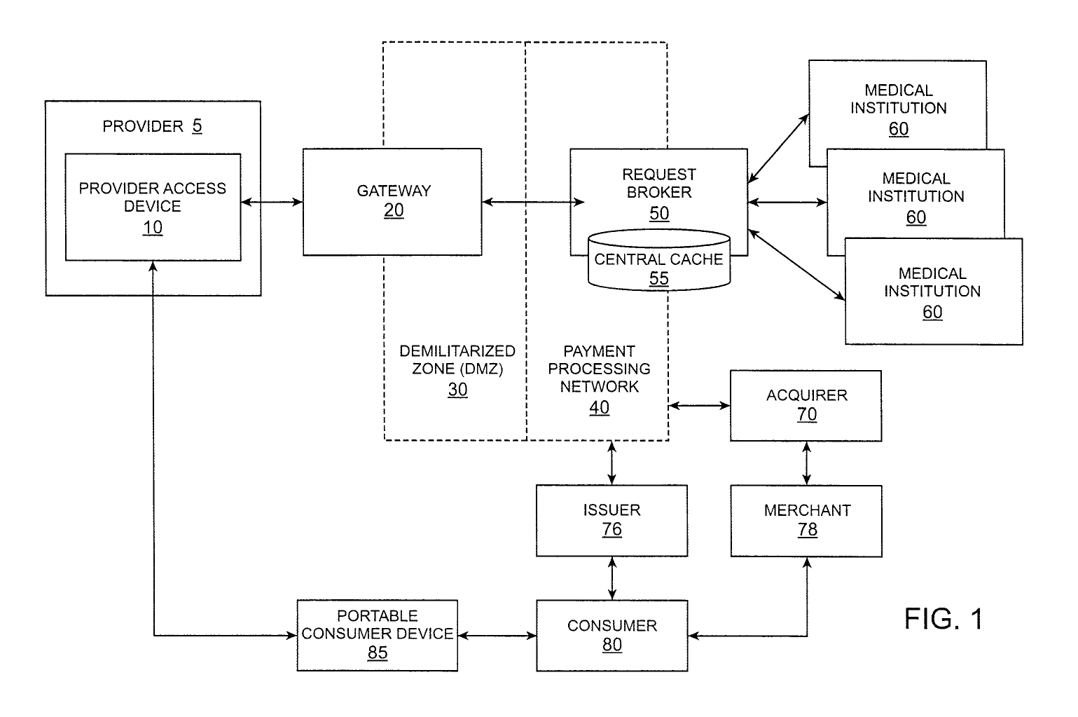

FIG. 1 shows a system that can be used in an embodiment of the invention. For simplicity of illustration, one provider, one provider access device, one gateway, one request broker, several medical institutions, one issuer, one portable consumer device, one consumer, one acquirer and one merchant are shown. It is understood, however, that embodiments of the invention may include multiple providers, gateways, request brokers, medical institutions, etc. In addition, some embodiments of the invention may include fewer than all of the components shown in FIG. 1. Also, the components in FIG. 1 may communicate via any suitable communication medium (including the Internet), using any suitable communication protocol.

The system in FIG. 1 includes a provider 5 and a provider access device 10 associated with the provider 5. In a typical transaction a provider 5 may use the provider access device 10 to request patient information at one or more medical institutions 60 via a request broker 50 and payment processing network 40. The request broker 50 may be in operative communication with one or more medical institutions 60.

The provider 5 may be an individual such as a doctor, a nurse, health administration personnel, pharmacist, insurance carrier, etc., who may use a provider access device 10.

The provider access device 10 may be in any suitable form. For example, suitable provider access devices can be point of sale (POS) devices, cellular phones, personal digital assistants (PDAs), personal computers (PCs), tablet PCs, handheld specialized readers, set-top boxes, electronic cash registers (ECR), automated teller machines (ATM), virtual cash registers (VCR), kiosks, access systems, and the like.

The demilitarized zone (DMZ) 30 may be a network area between the secure payment processing network 40 and another network such as the Internet. The gateway 20 may reside in the DMZ and may be a set of processes and shared libraries that translate requests and responses via a network such as the Internet or a mobile network, to handle connections and delivery of messages to and from the provider 5.

The request broker 50 may be software or a combination of hardware and software to support message routing, marshalling data, and support for distributed transactions. The request broker 50 may utilize a central cache 55 which may be a data store on the network that provides a collection of data duplicating original data from primary sources such as medical institutions 60. The typical type of data that may be stored in the central cache 55 may include information such as general patient information (name, address, etc.), patient medical history and records, laboratory results, x-ray results, radiology reports, medical problem lists, prescription information, allergies, blood type, immunization history, clinical notes such as physician and nursing notes about the patient, insurance information and coverage, etc.

The central cache 55 may be populated each time a request is made to the request broker 50 and information is acquired from one or more medical institutions 60. The central cache 55 may also be populated by a batch upload from each medical institution 60 on a regular basis (e.g., daily, weekly, monthly).

The central cache 55 may further provide locality of reference to improve performance and availability. Having a central cache 55 at the request broker 50 rather than just having an index and then a remote cache at each medical institution 60 is less expensive, faster, more reliable, and is better for security and privacy purposes. It is less expensive because the equipment and storage space for the central cache 55 only needs to be available at the central location versus having the equipment and space and each and every medical institution 60. It is faster and more reliable because accessing the cached copy rather than re-fetching the original data reduces the average access time to acquire the data. It is better for security and privacy purposes because security only needs to be implemented in a central location and it provides less locations for a security breach. It is also more secure since it may reside in a payment processing network 40 which is typically a private network segment used for very secure and private financial transactions.

In a centralized system the request broker 50 with the central cache 55 is a single logical instance which may be either a single physical instance or redundant depending on the required service levels. In a distributed system the request broker 50 with the central cache 55 can be multiple logical instances. In one version of either the centralized or distributed system, the request broker 50 with the central cache 55 can be logically distributed (e.g., on a regional basis) to improve large scale deployment performance and availability.

The medical institution 60 may be a hospital, pharmacy, laboratory, insurance carrier, provider, etc. that is a data source for patient records and information.

The payment processing network 40 is a secure network area which is typically a private network segment. It may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base 11 system which performs clearing and settlement services. The payment processing network 40 may use any suitable wired or wireless network, including the Internet. Typically this type of payment processing network is used for secure financial transactions. Using this type of network for health services information is ideal since transactions relating to patient health information also need to be secure and efficient.

FIG. 1 also shows an issuer 76, consumer 80, portable consumer device 85, acquirer 70, and merchant 78 to demonstrate functionality of a payment processing network 40 for commercial transactions. The acquirer 70 is typically a bank that has a merchant account. The issuer 76 may also be a bank, but it could also be a business entity such as a retail store. Some entities are both acquirers and issuers. The consumer 80 may be an individual, or an organization such as a business that is capable of purchasing goods or services. The merchant 78 may be an individual or an organization such as a business that is capable of providing goods and services.

The portable consumer device 85 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular and mobile phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

The portable consumer device 85 may further include a contactiess element, which is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 85 and a payment processing network 40 or it can be used to exchange data between the portable consumer device 85 and the merchant 78. Thus, portable consumer device 85 is capable of communicating and transferring data and/or control instructions via near field communications capability.

In a typical purchase transaction, the consumer 80 purchases a good or service at the merchant 78 using a portable consumer device 85 such as a credit card. The consumer's portable consumer device 85 can interact with an access device such as a POS (point of sale) terminal at the merchant 78. For example, the consumer 80 may take a credit card and may swipe it through an appropriate slot in the POS terminal. Alternatively, the POS terminal may be a contactless reader, and the portable consumer device 85 may be a contactless device such as a contactless card.

An authorization request message is then forwarded to the acquirer 70. After receiving the authorization request message, the authorization request message is then sent to the payment processing network 40. The payment processing network 40 then forwards the authorization request message to the issuer 76 of the portable consumer device 85.

After the issuer 76 receives the authorization request message, the issuer 76 sends an authorization response message back to the payment processing network 40 to indicate whether or not the current transaction is authorized. The payment processing network 40 then forwards the authorization response message back to the acquirer 70. The acquirer 70 then sends the response message back to the merchant 78.

After the merchant 78 receives the authorization response message, the access device at the merchant 78 may then provide the authorization response message for the consumer 80. The response message may be displayed by the POS terminal, or may be printed out on a receipt.

At the end of the day, a normal clearing and settlement process can be conducted by the payment processing network 40. A clearing process is a process of exchanging financial details between an acquirer and an issuer to facilitate posting to a consumer's account and reconciliation of the consumer's settlement position. Clearing and settlement can occur simultaneously.

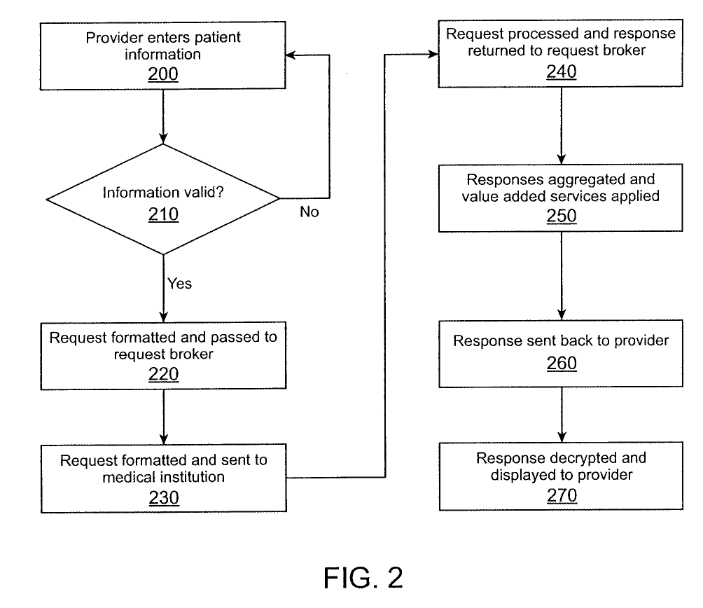

FIG. 2 shows a flowchart including a general method according to an embodiment of the invention. The method can be described with reference to the block diagram in FIG. 1.

First, the provider 5 may use a provider access device 10 to request patient information (e.g., medical records, lab results) from one or more medical institutions 60 (e.g., hospital, laboratory). The provider 5 may request specific records such as recent lab results or drug allergy information, or the provider 5 may request all of the patient's records and medical history. The patient may have a portable consumer device 85 such as an insurance card, a healthcare information card, a credit card, debit card, etc. or a multi-function card that has several functions all on one card such as credit and/or debit capabilities, insurance information, identification, and healthcare information. The provider access device 10 may be a desktop computer or a handheld mobile device where the provider 5 may enter patient information (e.g., the patient's name or medical record number) manually into the provider access device 10 (step 200). In the alternative, the provider access device 10 could be a POS and instead of entering the patient information manually, the patient's portable consumer device 85 can interact with the POS terminal. For example, the provider 5 may request patient information by swiping the patient's card through an appropriate slot in a POS terminal. Alternatively a POS terminal may be a contactless reader, and the patient's information may be in a contactless card.

The provider access device 10 may comprise a program such as a plug in hereinafter referred to as a provider client. The provider client may be software which allows the provider access device 10 to perform such functions as determining the validity of a patient information request, requesting information from a medical institution 60 through a request broker 50 via a payment processing network 40, and providing security and decryption for responses from medical institutions 60.

The provider client validates the information entered by the provider 5 (step 210). If the information is not valid, a message is displayed on the provider access device 10 to alert the provider 5 that the request is invalid and to prompt the provider 5 to re-enter the patient information. For example, a message may be displayed on the provider access device that says “request invalid, please re-enter patient information.”

Once the information entered by the provider 5 into the provider access device 10 is validated, the provider client formats the request and connects to the gateway 20. The provider client and the gateway 20 authenticate each other and the request is then passed to the gateway 20.

The gateway 20 receives the request from the provider access device 10 and passes the request to the request broker 50 in the payment processing network 40 (step 220). As an alternative (or in addition) to validation of the request by the provider client, the request broker 50 may check if the request is valid. If the request is not valid, a message is returned to the provider access device 10, through the gateway 20, to alert the provider 5 that the request is invalid. For example, a message may be displayed on the provider access device that says “request invalid, please re-enter patient information.”

If the request is valid then the request broker 50 builds a routing map which is a list of medical institutions 60 associated with the patient which may contain patient information. For each medical institution 60 in the routing map, the request broker 50 checks the central cache 55 for a recent match. If there is a recent match then the request broker does not need to request information from that medical institution 60 but instead can use the information already stored in the central cache 55. If there is not a recent match then the request broker 50 formats the request, sends the request to the medical institution 60 (step 230) and waits for a response from the medical institution 60.

If there are no dependencies between requests, asynchronous collection is possible which means that the request broker 50 may receive responses back from the medical institutions 60 in any order. If there are dependencies between requests, synchronous collection is preferred. Instead of receiving the responses from the medical institutions 60 in any order, for each medical institution 60 in the routing map, the request broker may connect to the medical institution 60, send the request and wait for a response. Once the response is received from the medical institution 60 (or if it is timed-out because there is no response), the request broker 50 drops the session and processes the next medical institution 60 until each one has been processed.

If the request broker 50 does not receive a response from the medical institution 60 in an allotted period of time (e.g., a few seconds), the request times out and a new request is formatted and sent. If an alternative source is available, the alternative source is queried. After a number of tries (e.g., three tries), the request broker 50 stops making a request to the medical institution 60, a “Not-Available” place holder is supplied for the missing data and processing continues.

The medical institution 60 receives the request for information, processes the request and then passes back a response to the request broker 50 (step 240).

Once the request broker 50 receives all of the responses back from the medical institutions 60 (in either an asynchronous or synchronous collection), it stores the responses in the central cache 55 and aggregates the responses (step 250). The request broker 50 can handle various types of responses. For example, the responses may be opaque which means that the request broker does not have visibility into the contents of the response. An opaque response may also be encrypted. If the response is not opaque, the request broker may also apply value added services to the response (step 250). Value added services may be edits, augmentation, and/or normalization. The response is sent to the gateway 20 which passes the response to the provider client on the provider access device 10 (step 260). The provider client receives the response, decrypts any opaque segments and presents the data to the provider 5 (step 270), which is displayed on the provider access device 10.

In a more specific example, a patient goes to his doctor to for his annual check-up and the doctor advises him to have blood work done to test his cholesterol and return in a week to discuss the results. The patient then goes to the laboratory, which is a separate organization to have his lab work done. Once the patient returns to the doctor for his follow-up appointment, the doctor manually enters the patient's name and/or medical record number into his computer or if the patient has a credit card or insurance card, the doctor swipes the card through a slot in a POS terminal to request the patient's medical records and lab results from the blood work he had done. Alternatively a POS terminal may be a contactless reader, and the patient's information may be in a contactless card.

If the doctor enters the patient's information incorrectly, he will receive a message on his computer screen or on the POS device that the information was not entered correctly. The doctor can then re-enter the information or re-swipe the patient's card.

Once the information is correctly entered, the request is sent through a gateway to a request broker that handles acquiring all of the requested information via a payment processing network. The request broker requests the patient information from each medical institution that has the requested information such as the lab where the patient had his blood work done. The request broker will first check the central cache to see if the information was recently requested (maybe the doctor reviewed the lab results earlier that day before the appointment with the patient). If the information is in the central cache then the request broker can return the response directly from the central cache. Otherwise it makes a request directly to the lab. When it gets the response from the lab it stores it in the central cache for quick retrieval next time and then returns the response to the doctor via the payment processing network and a gateway. The doctor can then review the patient's records that are displayed on his computer screen or POS device and go over the lab results with the patient.

The patient may also use the portable consumer device 85 to make his co-pay before receiving treatment from the provider 5. The portable consumer device 85 may be a credit card or insurance card combined with a credit card. The patient may present the card to the provider 5 at the time of his treatment. The provider 5 may use the portable consumer device 85 to request patient information (e.g., the co-pay amount from the patient's insurance provider and/or general patient records), as described above, and/or to pay the patient's co-pay by swiping the patient's card through an appropriate slot in a POS terminal. Alternatively a POS terminal may be a contactiess reader, and the patient's information may be in a contactless card.

The request for information from medical institutions associated with the patient goes through the same process as described above. If using the portable consumer device 85 to make a co-pay, a payment request is then sent to the payment processing network 40 via the gateway 20. The payment processing network 40 then forwards the payment request message to the issuer 76 of the portable consumer device 85.

After the issuer 76 receives the payment request message, the issuer 76 sends an authorization response message back to the payment processing network 40 to indicate whether or not the current transaction is authorized. The payment processing network 40 then forwards the authorization response message back to the provider 5 via the gateway 20.

After the provider 5 receives the authorization response message, the provider access device 10 at the provider 5 may then provide the authorization response message for the patient. The response message may be displayed by the POS terminal, or may be printed out on a receipt.

At the end of the day, a normal clearing and settlement process can be conducted by the payment processing network 40. A clearing process is a process of exchanging financial details between an acquirer and an issuer to facilitate posting to a consumer's account and reconciliation of the consumer's settlement position. Clearing and settlement can occur simultaneously.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
collecting medical information from various medical institutions via a payment processing network;
storing the collected medical information at a central location; and
providing, upon request, specific medical information to a requester from the stored collected medical information.

2. The method of claim 1 wherein medical information includes patient information, medical history, medical records, laboratory results, x-ray results, radiology reports, medical problem lists, prescription information, allergies, blood type, immunization history, clinical notes and insurance information and coverage.

3. The method of claim 1 wherein medical institutions include hospitals, pharmacies, laboratories, insurance carriers, and provider offices.

4. The method of claim 1 wherein the payment processing network is configured to process credit cards and financial transactions.

5. The method of claim 1 wherein a requester includes a doctor, nurse, health administration personnel, pharmacist, and insurance carrier.

6. A computer readable medium comprising:
code for collecting medical information from various medical institutions via a payment processing network;
code for storing the collected medical information at a central location; and
code for providing, upon request, specific medical information to a requester from the stored collected medical information.

7. A server comprising the computer readable medium of claim 6.

8. A system comprising:
means for collecting medical information from various medical institutions via a payment processing network;
means for storing the collected medical information at a central location; and
means for providing, upon request, specific medical information to a requester from the stored collected medical information.

9. A method comprising:
requesting medical information using a provider access device wherein the requested medical information is collected from various medical institutions via a payment processing network and stored at a central location; and
receiving the medical information wherein the requested medical information is provided from the stored medical information.

10. The method of claim 9 wherein a provider access device includes a point of sale device, cellular phone, personal digital assistant, personal computer, tablet personal computer, handheld specialized reader, set-top box, electronic cash register, automated teller machine, virtual cash register, kiosk, and access system.

11. The method of claim 9 wherein medical information includes patient information, medical history, medical records, laboratory results, x-ray results, radiology reports, medical problem lists, prescription information, allergies, blood type, immunization history, clinical notes and insurance information and coverage.

12. The method of claim 9 wherein medical institutions include hospitals, pharmacies, laboratories, insurance carriers, and provider offices.

13. The method of claim 9 wherein the payment processing network is configured to process credit cards and financial transactions.

14. A computer readable medium comprising:
code for requesting medical information using a provider access device wherein the requested medical information is collected from various medical institutions via a payment processing network and stored at a central location;
code for receiving the medical information wherein the requested medical information is provided from the stored medical information.

15. A method comprising:
receiving a request for medical information from a request broker via a payment processing network; and
providing the medical information to the request broker via a payment processing network wherein the medical information is stored at a central location.

16. The method of claim 15 wherein medical information includes patient information, medical history, medical records, laboratory results, x-ray results, radiology reports, medical problem lists, prescription information, allergies, blood type, immunization history, clinical notes and insurance information and coverage.

17. The method of claim 15 wherein the payment processing network is configured to process credit cards and financial transactions.

18. A computer readable medium comprising:
code for receiving a request for medical information from a request broker via a payment processing network;
code for providing the medical information to the request broker via a payment processing network wherein the medical information is stored at a central location.

19. A server comprising the computer readable medium of claim 18.

20. A method comprising:
requesting medical information using a portable consumer device wherein the requested medical information is collected from various medical institutions via a payment processing network and stored at a central location; and
receiving the medical information wherein the requested medical information is provided from the stored medical information.

21. The method of claim 20 wherein a portable consumer device includes a credit card, debit card, and health insurance card.

22. A method comprising:
requesting medical information using a portable consumer device wherein the requested medical information is collected from various medical institutions via a payment processing network and stored at a central location;
receiving the medical information wherein the requested medical information is provided from the stored medical information;
sending a payment request using the portable consumer device;
receiving an authorization response message indicating that payment is authorized.
